(19) United States
(12) Patent Application Publication
(10) Pub. No.: US 2004/0118504 A1
(43) Pub. Date: Jun. 24, 2004

(54) Method for manufacturing a composite material, method for manufacturing a three-dimensional component made of a composite material, composite material, and device for holding the composite material

(75) Inventors: Hans-Georg Herrmann, Ravensburg (DE); Asmir Salkic, Ulm (DE); Robert Bjekovic, Ehingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/712,506

(22) Filed: Nov. 13, 2003

(30) Foreign Application Priority Data
Dec. 20, 2002 (DE) 102 59 883.5-16
Nov. 14, 2002 (DE) 102 52 998.1-11

(51) Int. Cl. B32B 31/00

(52) U.S. Cl. 156/160; 156/494

(57) ABSTRACT

A method for manufacturing a composite material having orientated thermoplastics and non-orientated thermoplastics or only orientated thermoplastics and a three-dimensional component manufactured using the composite material. The composite material is heated to a temperature level above the stress-free melting point of the higher-melting thermoplastics. A mechanical stress is applied within the composite material using a device for holding the composite material in order to temporarily raise the melting point of the orientated thermoplastics during shaping, thus ensuring the component quality.

Priority is claimed to German Patent Application Nos. DE 102 52 998.1-11, filed on Nov. 14, 2002 and DE 102 59 883.5-16, filed on Dec. 20, 2002. The entire disclosure of both applications is incorporated by reference herein.

### BACKGROUND

The present invention relates in general to the area of material processing, and in particular to a method for manufacturing a composite material and a method for manufacturing a three-dimensional component, as wells as to a composite material, and a device for holding orientated thermoplastics or orientated and non-orientated thermoplastics of a composite material.

A method for manufacturing a component is known from European Patent Document EP 531 473 B1 in which multiple layers of a fabric made of orientated polymers (characterized by semi-crystalline areas) are placed on top of one another and are subsequently partially melted together under a pressure which is higher than the atmospheric pressure. The emerging melted mass of now non-orientated polymers (a predominantly amorphous structure) forms a second phase which acts as the matrix for the composite material. The fibers of the fabric bond with the melted mass so that a monolithic component is formed from the fabric layer like a sintered body. However, such a component tears relatively easily in the area of the individual fabric layers and is in addition relatively expensive to manufacture. In this method, the particular fibers are only melted on their surface which requires a very complex and thus expensive temperature control. In addition, the melting of the fiber surface has a disadvantageous effect on the surface quality of the fibers (the fibers lose their contours) and their material properties. Empty hollow spaces which remain unfilled between the melted fibers also have a disadvantageous effect on the material properties. The mechanical properties (elasticity modulus, tensile strength, impact strength, among other things), as well as thermal properties (temperature resistance) and shapability, are thereby negatively affected. Creases, delaminations, and microcracks occur in components which are manufactured using this method.

In contrast to EP 531 473 B1, an improved method for manufacturing a component having an internal layer of synthetic material and a component which has improved stability and rigidity using this method are the subject of German Patent Document DE 100 17 493 A1. For manufacturing the component, a layer of synthetic material in powder form and/or foil form is introduced between two adjacent fabric layers, subsequently heated and bonded together under pressure. The synthetic material of one or multiple layers of synthetic material is partially melted and subsequently cooled off after the desired final shape is achieved. In contrast to components which are the object of EP 531 473 B1, components which are produced following this manufacturing method have better mechanical properties and are manufactured more cost-effectively. Microscopic tests show that at low degrees of shaping, satisfactory shaping results are achieved in these components. In spite of improved properties, these components also show non-tolerable deficiencies such as creases, for example, at high degrees of shaping.

### SUMMARY OF THE INVENTION

An object of the present invention is to provide a composite material, as well as a method for manufacturing same, and for manufacturing a three-dimensional component made of the composite material which does not have the above-mentioned disadvantages or has them only in a reduced form.

The present invention provides a method for manufacturing a composite material which contains orientated thermoplastics and non-orientated thermoplastics. The orientated thermoplastics and the non-orientated thermoplastics are heated to a temperature level above the stress-free melting point of the higher-melting thermoplastics, the orientated thermoplastics being held under stress in the direction of their orientation, thereby raising their melting point.

Attention must be paid to the fact that the melting point of the orientated thermoplastics under stress is not reached or exceeded.

Surprisingly, it has been found that the melting point of the orientated thermoplastics rises under increased stress. This creates the advantage in the method according to the present invention that, due to the elevated operating temperature, better shaping of the composite material is made possible without causing a deterioration of mechanical properties as a result of melting the orientated thermoplastics. Through this, the method creates the prerequisites for the manufacture of composite materials having improved mechanical properties such as elasticity modulus, tensile strength, impact strength, and improved thermal properties such as temperature resistance. An additional advantage of this method lies in the fact that it represents an optimized process which is repeatable at any time.

The orientated thermoplastics have the advantage that they contain semi-crystalline thermoplastics which, for the most part, are composed of orientated crystallites, thus having better mechanical and thermal material properties than the amorphous non-orientated thermoplastics.

It should be pointed out that, although semi-crystalline areas predominantly characterize the orientated thermoplastics, they also have amorphous areas.

The orientated thermoplastics may exist in the form of, among other things, fibers, narrow bands, fiber bundles, semi-finished products such as wovens, scrims, mats, foils, nonwovens, or any combination of these or their consolidated products. Concrete examples of this are mat-type layers of crossed fibers and/or narrow bands of orientated polyolefins, in particular polypropylene. The non-orientated thermoplastics can exist in the form of foils and/or powder. The non-orientated thermoplastics, here also referred to as second phase, basically have a lower melting point compared to the orientated thermoplastics. According to the method for manufacturing a composite material, the orientated and non-orientated thermoplastics are pressed or processed with each other to form a composite material or a semi-finished product.

According to an advantageous refinement of the present invention, the same thermoplastics or the same thermoplastic mixtures can be processed with each other to form the composite material.

Manufacturing a composite material according to the present invention using the same particular thermoplastics has the advantage that recycling of the thermoplastics can be implemented in a particularly cost-effective manner. Manufacturing a composite material using the same thermoplastic mixtures, e.g., polyolefins, polypropylene, and polyethylene, in which the orientated, as well as the non-orientated, thermoplastics are made of the same mixture, makes controlled calibration of the particular required or desired material properties possible. This is possible because polyolefins can be easily mixed together.

Polypropylene or polyethylene and also polyamide or mixtures thereof are preferably suited as thermoplastics. According to a particular advantageous embodiment of the present invention, the composite material from the polyolefin group is selected due to its favorable characteristics such as recyclability, light weight, and low cost, among other things. In contrast to polyethylene, for example, polypropylene is particularly suited for this due to its better temperature resistance.

In an advantageous embodiment of the method according to the present invention for manufacturing a composite material, fibers and/or narrow bands containing orientated thermoplastics for the reinforcement of the composite material, as well as non-orientated thermoplastics, are used as the matrix for the composite material.

The fibers and/or narrow bands and the matrix may exist separately or in such a way that fibers and/or narrow bands made of orientated thermoplastics are sheathed by non-orientated thermoplastics. Here, the matrix which is sheathing the fibers and/or narrow bands is applied via coextrusion, coating and/or thermo-physical treatment.

Using fibers and/or narrow bands, the method according to the present invention makes it possible that the composite material has desired properties in a preferred direction (direction dependency of the material properties).

According to the present invention, the initial product for the matrix of the composite material can exist in the form of powders or foils made of non-orientated thermoplastics. A foil as the matrix is practical since it is easy to introduce. A powder as the matrix has the advantage, among other things, that, in the solid state, it better penetrates the freely formed hollow spaces between the fibers and/or narrow bands and can thus better fill the freely formed hollow spaces.

The method for manufacturing a composite material according to the present invention ensures that, under a pressure which is higher than the atmospheric pressure, the matrix of the composite material melts earlier and fills hollow spaces than the fibers and/or narrow bands which are held under stress and which reinforce the composite material. The matrix thus acts as a cohesive and stabilizing bonding factor. The reduction of the hollow spaces within the composite material has a positive effect on the mechanical and thermal properties.

In a further advantageous embodiment of the method according to the present invention, the composite material is composed of at least one layer of orientated thermoplastics and at least one layer of non-orientated thermoplastics.

This facilitates the monolithic bonding of the layer of orientated thermoplastics with the layer of non-orientated thermoplastics during a heat treatment of the composite material.

An appropriate design of the method according to the present invention provides that one layer of non-orientated thermoplastics is pressed together with one layer of orientated thermoplastics adjacent on both sides.

This construction makes an advantageous reinforcement of the composite material possible. The non-orientated thermoplastics melt before the orientated thermoplastics which are held under stress and thus also before this layer is affected by heat. The matrix material largely protects the fibers and/or narrow bands of the layer of orientated thermoplastics from the heat application. The entire procedure is simplified overall and thus less expensive due to the lesser exposure of the fibers and/or narrow bands.

In a further embodiment of the method according to the present invention, multiple layers of orientated thermoplastics are pressed together with multiple layers of non-orientated thermoplastics to form a composite material.

The number of the layers being held under stress depends on the desired strength, as well as the desired mechanical and thermal properties, and the intended application of the composite material.

According to a particularly advantageous embodiment of the method according to the present invention, the layers of orientated thermoplastics are designed as a fabric in such a way that, for reinforcing the composite material in the warp direction, a first plurality of essentially parallel fibers and/or narrow bands is interwoven with a second plurality of essentially parallel fibers and/or narrow bands for reinforcing the composite material in the weft direction. An angle of 45°-135°, in particular 90° between warp and weft, is preferred here.

This has the advantage that, during insertion, the fibers and/or narrow bands which are perpendicular to one another allow the same mechanical and thermal properties of the composite material in each 90° direction.

In a further embodiment of the method according to the present invention, two fabrics are positioned on top of one another and interwoven in such a way that angles of approximately 45° are formed between the respective pluralities of essentially parallel fibers and/or narrow bands reinforcing the composite material. This makes preferably direction-independent (isotropic) material properties in the composite material possible.

In a further embodiment of the method according to the present invention, the fibers and/or narrow bands for reinforcing the composite material are interwoven among each other in the warp direction to form threads (twists made of individual fibers and/or narrow bands which are interlaced with one another). To simultaneously form two fabrics on top of one another, which are interwoven among each other via threads, multiple threads are needed in the warp direction. The threads change from one fabric layer to the next. Two different interweaving combinations are created in this way. This double fabric is used in order to achieve preferably direction-independent (isotropic) material properties in the composite material.

In a further advantageous embodiment of the method according to the present invention, in the initial state of the layer, its fibers and/or narrow bands run predominantly linearly and are uninterrupted to the greatest possible extent over the entire length of a semi-finished product or swatch.

This has the advantage that, due to the stretched layer of the composite material, the fibers can withstand considerable tensile forces after the layer is shaped into a saucer-type component shape, for example. The tensile forces effective in the direction of the orientation of the orientated fibers and/or narrow bands have an advantageous effect on the draping of the composite material or the semi-finished product, the draping accordingly taking place free of creases.

In a further advantageous embodiment of the method according to the present invention, the composite material is made of polyolefins. Polypropylene composite materials, reinforced according to the present invention, are particularly suited for applications in the automotive industry, e.g., for manufacturing underbodies, due to their light weight and their strength.

Another advantage of the composite material made of polypropylene is its recyclability and, in contrast to other polyolefins (e.g., polyethylene), its better thermal properties such as temperature resistance. This multifaceted material can be recycled and may find further use in automotive engineering, in the car interior trim, e.g., a hat rack, or in the trunk for suitcase storage. It is also popular because of its good skin tolerance.

A further object of the present invention is a method for manufacturing a three-dimensional component made of a composite material which contains orientated thermoplastics and non-orientated thermoplastics, the orientated thermoplastics and the non-orientated thermoplastics being heated to a temperature level above the stress-free melting point of the higher-melting thermoplastics. The composite material is held under pressure in a three-dimensional mold, while the orientated thermoplastics of the composite material are held under stress in a device for holding the composite material in the direction of their orientation.

It should be pointed out here that the composite material could be a composite material manufacturable according to the above-described method, as well as a fixed or loose composite of orientated and non-orientated thermoplastics manufactured by other methods. This means that, in a method according to the present invention for manufacturing a three-dimensional component using a composite material of the first type, the composite material is heated a second time; if a composite material of the second type is used, the heating according to the method can be a first-time heating.

The component manufactured according to this method has the advantages over conventional components in that it has fewer creases, delaminations, and/or microcracks. During the heating, the matrix of the composite material forms a melt, which does not solidify during shaping, therefore ensuring a better shapability. Such components are undistorted and have less internal stresses.

Heating of the composite material may take place contactless, via convection oven, ultrasound, IR reflector (quartz, halogen, or ceramic reflector), or by using contact heating.

Compared to usual components, a component manufactured following the method according to the present invention has improved mechanical properties such as elasticity modulus, tensile strength, and impact strength, as well as better thermal properties such as temperature resistance.

According to an advantageous design of the method for manufacturing a three-dimensional component according to the present invention, a composite material is used which is manufactured following the method for manufacturing a composite material according to the present invention.

This ensures good mechanical and thermal material properties.

A further object of the present invention is a composite material made of orientated and non-orientated thermoplastics which is manufacturable following the method for manufacturing a composite material according to the present invention.

This composite material according to the present invention has improved mechanical and thermal material properties.

A further object of the present invention is a device for holding a composite material, which contains a holding fixture which has at least three access surfaces for fixing the composite material, as well as means for applying a tensile stress to the composite material.

The composite material may be inserted into the device for holding a composite material at room temperature.

It is advantageous that the at least three access surfaces, with which the composite material or the layers of orientated and the layers of non-orientated thermoplastics are secured, are statically designed so that, by securing, a mechanical stress is applied to the composite material or it has an internal mechanical stress.

All static or dynamic devices which, via positive fits and/or frictional connections applied to the edge, act against the thermally induced tensile stresses in the component are understood to be a device for holding a composite material. The positive fits and/or frictional connections can preferably be designed as detachable contact connectors (mechanical and/or pneumatic clamps, needles, grippers, threaded contacts, etc.).

According to a particularly advantageous embodiment of the present invention, the means for applying a tensile stress are positioned in such a way that, when holding a composite material according to the present invention, the tensile stress is essentially applied in the direction of the orientation of the orientated thermoplastics.

This positioning of the means for applying a tensile stress ensures that the tensile stress is applied in the direction of the orientation of the orientated thermoplastics. This causes a rise in their melting point. The external tensile stress also acts against the thermally induced tensile stresses in the composite material. In addition, bending of the composite material being secured during the heating phase is prevented. This results in a considerable improvement of the material properties of a component after the shaping phase.

If, at a given tensile stress, components made of orientated thermoplastics are heated to a temperature above the melting point of the orientated thermoplastics being under stress, then rapid re-shaping (stretch relaxation) occurs in the material. This results in a failure of the usual securing devices on the access surfaces, thus complicating shaping of a material or semi-finished product made of the orientated thermoplastics.

The design of the device for holding a composite material according to the present invention ensures securing of the composite material in which no re-shaping having a negative effect occurs in the secured composite material. The known present temperature limits for the orientated thermoplastics, at which relaxing processes start, are displaced to higher values so that little stretch relaxations occur in the composite material within the known temperature limits. This facilitates improved processing of the orientated thermoplastics by shaping.

In an embodiment of the device according to the present invention, the at least three access surfaces for fixing are approximately designed as access points.

In a particularly advantageous embodiment of the present invention, the at least three access surfaces for fixing the composite material have thermal shieldings and/or insulations.

The device for holding a composite material is preferably provided with insulation systems which serve the purpose of shielding the access surfaces for securing the composite material from too high a temperature, as well as insulating the composite material from a high temperature at the fixing points. These insulation systems, representing constructive devices, ensure minimization, delay, or prevention of the heating in the access surfaces for securing the composite material and in the fixing points of the composite material. Composite material damage through softening, subsequent melting, and then tearing out can thereby be prevented at the fixing points (force application points) of the composite material, presuming that the composite material is sufficiently rigid at the fixing points, in order to absorb tensile strengths which occur during heating without tearing. This is the case in the composite material according to the present invention.

Using computations, the distance of the thermal shieldings and/or insulations of these insulation systems from the heat source is optimized to the effect that no material damage in the composite material occurs due to the thermal treatment.

According to a refinement of the device according to the present invention, the at least three access surfaces for fixing the composite material are designed as clamps.

Materials, whose rigidity is sustained up to 400° C., are preferably used for the clamps, in particular metal, metal alloys, plastics, wood, ceramic and/or composite material.

In an advantageous refinement of the device according to the present invention, fixing points of the composite material are positioned outside of a heating field.

Positioning the fixing points of the composite material outside of the heating field at an adequate distance from the heat source results in hardly any heat energy being supplied to these points due to the construction. This is advantageous for designing the access surfaces for fixing the composite material as clamps.

In a further advantageous embodiment of the device according to the present invention, the thermally insulated fixing points of the composite material are designed as grippers.

Similar advantages are achieved using this design, as is the case with the clamp design.

In a further advantageous embodiment of the device according to the present invention, the at least three access surfaces for fixing the composite material are situated within a frame.

The composite material and/or the orientated thermoplastics are secured and held in the frame pair composed of a lower and an upper frame. This device for holding orientated thermoplastics is made of a material which sustains a required rigidity at temperatures of up to 400° C.

Metal, metal alloys, plastics, wood, ceramic, and/or a composite material are considered to be suitable materials for the frame pair. The thermally insulated access surfaces for securing this device are positioned in the area of the corners of the layers of the orientated thermoplastics or composite material.

### BRIEF DESCRIPTION OF THE DRAWINGS

The present invention is explained in greater detail in the following based upon exemplary embodiments and the FIGS. 1 through 3, in which:

FIG. 1 shows a schematic representation of a first embodiment of the device according to the present invention for holding the composite material made of orientated and non-orientated thermoplastics which is secured via eight access surfaces and held in a frame;

FIG. 2 shows a schematic representation of thermal insulations and/or shieldings; and

FIG. 3 shows a schematic representation of a second embodiment of the device according to the present invention having clamps.

### DETAILED DESCRIPTION

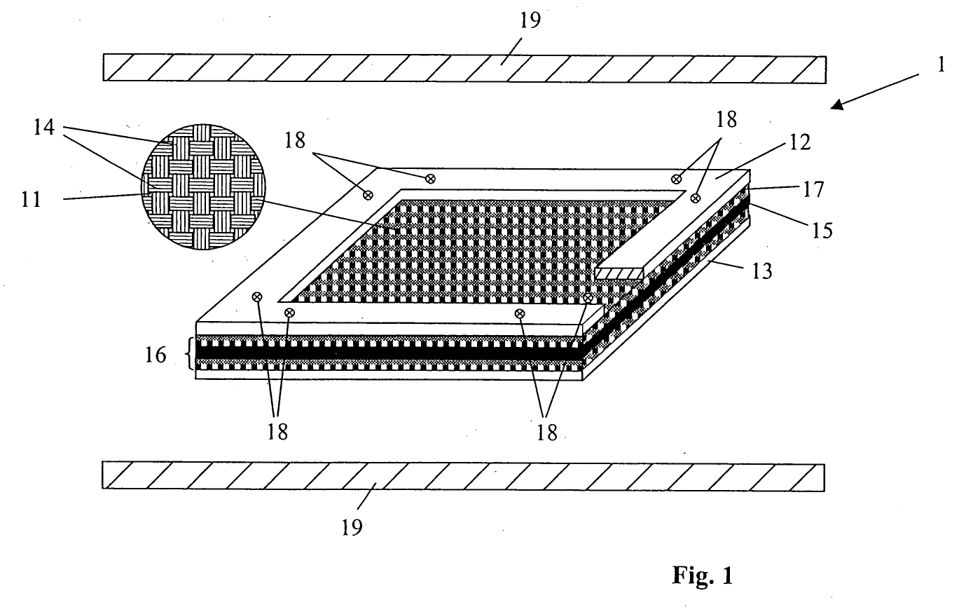

In a first exemplary embodiment according to FIG. 1, fibers and narrow bands 14, containing orientated polypropylenes for reinforcing composite material 16, as well as non-orientated polypropylenes as the matrix of composite material 16, are used in the method for manufacturing a composite material 16.

Fibers and narrow bands 14 for reinforcing composite material 16 are predominantly made of semi-crystalline areas which, for the most part, contain orientated crystallites. Fibers and narrow bands 14 for reinforcing composite material 16 also contain areas of non-orientated polypropylenes. The orientated crystallites of the polypropylenes have better mechanical and thermal properties than the amorphous non-orientated polypropylenes.

The matrix of composite material 16 exists in the form of foils made of non-orientated polypropylenes 15. Compared to the orientated polypropylenes, the non-orientated polypropylenes have a lower melting point. Thus, the matrix of the composite material is basically melted earlier than the fibers and narrow bands 14 and acts as a supporting bonding phase.

Fibers and narrow bands 14 for reinforcing composite material 16 are processed into layers 17 in such a way that a first plurality of essentially parallel fibers and narrow bands 14 for reinforcing composite material 16 in the warp direction are interwoven with a second plurality of essentially parallel fibers and narrow bands 14 for reinforcing composite material 16 in the weft direction, an angle of 90° existing between warp and weft.

According to this embodiment, composite material 16 is manufactured using two layers of orientated polypropylene 17, one layer of non-orientated polypropylene, designed as foil 15, being situated between them.

During a first heat treatment of the layers at a temperature of 165° C. they are pressed together perpendicularly to the surface to form a composite material 16 under a pressure of approximately 36 bar. The freely formed hollow spaces 11 between warp and weft in the layer of orientated polypropylenes 17 are filled by the melted foil of non-orientated polypropylenes 15.

Subsequent to this first heat treatment, composite material 16 is secured at room temperature under tensile stress into a device 1 for holding composite material 16 and is subsequently subjected to a second heat treatment. This results in the above-mentioned improved shaping properties.

As can be seen from FIG. 1, device 1 for holding a composite material 16 is made up of a frame pair which in turn has an upper frame 12 and a lower frame 13. Device 1 has eight access surfaces 18 for securing composite material 16. Eight fixing points or force application points are formed in these eight access surfaces 18. The positions of the fixing points or force application points are determined using a computer program (simulation program) in order to ensure a homogeneous tensile stress distribution within the composite material after joining. The arrangement of the eight fixing points or force application points in composite material 16 is computed and designed in such a way that hardly any material damage occurs on composite material 16 in the area of the fixing points or force application points due to the second heat treatment. Boreholes are introduced at the computed positions of these fixing points or force application points at an earlier computed distance from the fixing points or force application points in the lower and upper frame 12 and 13 in such a way that, during joining of composite material 16 with the two frames 12 and 13, the boreholes do not overlap. Subsequent securing of composite material 16 ensures that the boreholes of the lower and upper frame overlap with the boreholes of composite material 16. Securing of the lower and upper frame 12 and 13 with composite material 16 at room temperature takes place using fastening elements, screws in this case, which are introduced into the boreholes. Defined and homogeneously distributed tensile stresses in composite material 16 are present in device 1 within composite material 16 after securing. Frames 12 and 13 secure composite material 16, made of two layers of orientated polyolefins 17 and one layer of non-orientated polyolefin 15 pressed together in such a way that they are under tensile stress in the direction of the orientation.

As can be seen from FIG. 1, fibers and narrow bands 14 in layer 17 run linearly and extend uninterrupted over the entire length of a semi-finished product.

The stretched fibers and narrow bands 14 in layer 17 of composite material 16 ensure that, after a second heat treatment and shaping of layer 17, fibers and narrow bands 14 can absorb considerable tensile forces.

Composite material 16, being under stress in a device 1 for holding a composite material, is heated to a temperature level of approximately 190° C. in a second heat treatment, thus above the stress-free melting point of the higher-melting orientated polypropylene (between 160° and 165° C.). Composite material 16, having a wall thickness of approximately 2.5 mm, is under stress in the direction of the orientation of the orientated polypropylene, whereby, after approximately 30 minutes, the melting point of the orientated polypropylene rises to over 200° C. so that it does not melt.

To achieve an improved homogeneous temperature distribution in composite material 16 or in the component, composite material 16, being under stress, is held at a temperature of 190° C. during the second heat treatment, the holding time being adapted to the wall thickness of the composite material and the heating conditions.

For a composite material 16 made of polypropylene having a wall thickness of approximately 2.5 mm, a holding time of approximately 30 minutes is selected under laboratory conditions in a test oven (convection oven) at a test temperature of 190° C. Material damage may occur if a significantly different holding time is used. The higher the heating temperature, the lesser the tendency of composite material 16 and ultimately the component to develop material flaws (such as creases, delaminations, and microcracks, for example). Therefore, a temperature as high as possible is selected below the melting point of the polypropylene under stress. The composite material is heated in a heating field 19.

Manufacturing and processing of a three-dimensional component from a composite material 16 which contains orientated and non-orientated polypropylene is divided into multiple consecutive process steps. Based upon a thermal process analysis, the optimum process parameters for a suitable procedure during the shaping phase are defined as follows:

Under a pressure of 60 bar (or more), a temperature above the stress-free melting point of the higher-melting orientated polypropylene of approximately 190° C., and a shaping rate specific for the material and the geometry of the component, here 1 mm/sec, composite material 16, being under stress, is pressed in a three-dimensional mold into a three-dimensional component in approximately 40 seconds.

Composite material 16 is held at this temperature (190° C.), while the orientated polypropylenes, in the direction of their orientation, are kept under stress in device 1 for holding composite material 16.

A tool temperature of the cooled upper and lower pressing mold of approximately 35° C. is reached here.

Composite material 16 is shaped into a three-dimensional component within frames 12 and 13 using a female mold or a male mold. Frames 12 and 13 are held in a fixed position with respect to the female mold situated on the bottom of the shaping press. Using a heating field 19, composite material 16 is heated to a temperature of approximately 190° for approximately 40 seconds. Composite material 16 is stretched and draped in the female mold by moving the female mold/frames back into the shaping press and by closing the forming tool. The composite material is thereby shaped into the desired shape. In order to perform the shaping of composite material 16 or the semi-finished product almost creaseless and crack-free, the tensile stress in composite material 16 applied by device 1 for holding a composite material 16 is maintained.

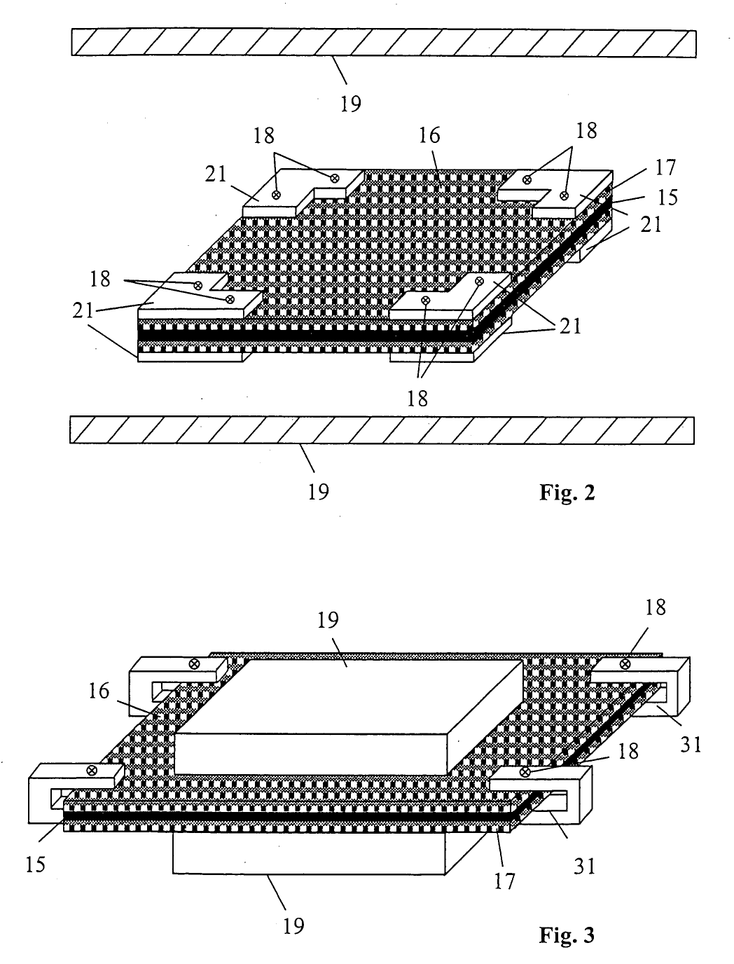

FIG. 2 shows an embodiment of thermal shieldings and insulations 21 according to the present invention.

These thermal shieldings and insulations 21 separate frames 12 and 13 from composite material 16 and are introduced in the corners of the layers of orientated polypropylenes 17. They shield access surfaces 18 for securing composite material 16 from improper heating and insulate composite material 16 at the fixing points. This shielding of access surfaces 18 and insulating of composite material 16 takes place in such a way that the temperature of composite material 16 and access surfaces 18 for securing composite material 16 does not significantly exceed 80° C. at these points. This ensures a minimization, delay, or prevention of heating in access surfaces 18 for securing composite material 16 or in the fixing points of the composite material. This makes it possible that device 1 for holding a composite material 16 absorbs thermally induced stresses. Thermal shieldings and insulations 21 from heating source 19 are designed and positioned using computations to the effect that hardly any material damage occurs in the composite material due to the thermal treatment.

Alternatively to this embodiment, frames 12 and 13 may be composed of a suitable material in such a way that they, in addition to their holding function, also take on the function of the thermal shieldings and insulations 21.

A simple embodiment of device 1 for holding a composite material 16 using clamps 31 is figuratively shown in FIG. 3.

Composite material 16 is positioned here in heating field 19 in such a way that part of composite material 16 lies outside of heating field 19 and is fastened using clamps 31.

Positioning the fixing points of composite material 16 outside of heating field 19 at an adequate distance from the heat source has the effect that, due to the construction, little heat energy is supplied to these points.

Four access surfaces 18, with which composite material 16 is secured, are designed in this exemplary embodiment in such a way that, by securing composite material 16, a mechanical stress is applied to composite material 16 at four fixing points and force application points, or composite material 16 has an internal mechanical stress. Boreholes are introduced into composite material 16 in correspondence with the four fixing points and force application points. Composite material 16 is sandwiched between clamps 31 and is secured by clamps 31 using fastening elements, screws in this case. Via clamps 31, composite material 16 is pulled in a defined manner into the computed positions of the fixing points and force application points and is thus subjected to a constant tensile stress. Clamps 31 are made of an insulation material and shield the composite material at the fixing points from improper heating.

The present invention is not limited to the exemplary embodiments described above; it is, rather, transferable to other embodiments.

The embodiments illustrated in the figures represent only one possibility out of a plurality of feasible variants. In particular, variations with respect to size and shape of the device for holding a composite material are certainly possible.

The advantages achieved through the present invention lie in the fact that, during shaping under optimized shaping parameters and accurately defined processing, tolerably few faulty spots, in particular creases, interlaminar and intralaminar delaminations, or microcracks, occur in the composite material in which the orientated thermoplastics are held under tensile stress in the direction of their orientation. The melting point of the orientated thermoplastics, i.e., the composite material, rises due to the application of a tensile stress in the orientated thermoplastics in the direction of their orientation. Improved mechanical and thermal material properties of the composite material such as elasticity modulus, tensile strength, and impact strength and improved temperature resistance result in improved component quality. Due to the optimized shaping conditions, components which are manufactured following the method for manufacturing a three-dimensional component made of a composite material have internal stresses which are reduced to a minimum. This facilitates the manufacture of undistorted components.

What is claimed is:

1. A method for manufacturing a composite material, the composite material including orientated thermoplastics having a first stress-free melting point and non-orientated thermoplastics having a second stress-free melting point, the method comprising:
heating the orientated and the non-orientated thermoplastics to a temperature level above the higher of the first and second stress-free melting points; and
holding the orientated thermoplastics under stress in a direction of their orientation.

2. The method as recited in claim 1, wherein the orientated thermoplastics and non-orientated thermoplastics are made of the same material.

3. The method as recited in claim 1, wherein the orientated thermoplastics and non-orientated thermoplastics are made of the same mixtures of material.

4. The method as recited in claim 1, wherein the orientated thermoplastics and the non-oriented thermoplastics form one of fibers and narrow bands.

5. The method as recited in claim 4, wherein the orientated thermoplastics form at least one orientated layer and the non-orientated thermoplastics form at least one non-orientated layer.

6. The method as recited in claim 5, wherein the at least one orientated layer form a fabric such that a first plurality of essentially parallel fibers and/or narrow bands configured to reinforce the composite material in a warp direction are interwoven with a second plurality of essentially parallel fibers and/or narrow bands configured to reinforce the composite material in the weft direction.

7. The method as recited in claim 6, wherein an angle between the warp and weft directions is from 45° to 135°.

8. The method as recited in claim 1, wherein the composite material includes polyolefins.

9. A method for manufacturing a three-dimensional component made of a composite material, the composite material including orientated thermoplastics having a first stress-free melting point and non-orientated thermoplastics having a second stress-free melting point, the method comprising:
heating the orientated and the non-orientated thermoplastics to a temperature level above a higher of the first and second stress-free melting points,
holding the composite material under pressure in a three-dimensional mold; and
holding the orientated thermoplastics of the composite material under stress in a direction of their orientation using a device for holding the composite material.

10. The method as recited in claim 9, wherein the composite material is manufactured according to a method as recited claim 1.

11. A composite material made of orientated and non-orientated thermoplastics, wherein the composite material is manufacturable according to the method as recited in claims 1.

12. A device for holding a composite material, comprising:
a fastening device having at least three access surfaces for securing the composite material; and
a stress device configured to apply a tensile stress to the composite material.

13. The device as recited in claim 12, wherein the composite material includes orientated and non-orientated thermoplastics and wherein the stress device is positioned so as to apply the tensile stress in a direction of an orientation of the orientated thermoplastics.

14. The device as recited in claim 12, further comprising a plurality of thermal shieldings corresponding to the at least three access surfaces.

15. The device as recited in claim 12 wherein the fastening device includes at least one clamp.

16. The device as recited in claim 12, wherein the at least three access surfaces are disposed within a frame.
